(19) United States
(12) Patent Application Publication
(10) Pub. No.: US 2015/0365574 A1
(43) Pub. Date: Dec. 17, 2015

(54) HANDHELD MOBILE APPARATUS WITH FOUR-DIRECTION PHOTOGRAPHY

(71) Applicant: CHANE-YU LAI, Shetou Township (TW)

(72) Inventors: CHANE-YU LAI, Shetou Township (TW); ANN-YU LAI, Shetou Township (TW)

(21) Appl. No.: 14/605,966

(22) Filed: Jan. 26, 2015

(30) Foreign Application Priority Data
Jun. 13, 2014 (TW) 103210478

(51) Int. Cl. H04N 5/225; H04N 7/14; H04N 5/372; G06T 7/00; H04N 5/374

(52) U.S. Cl. CPC H04N 5/2257; G06T 7/0077; H04N 5/374; H04N 5/372; H04N 7/142; H04N 5/2258; G06T 2207/10012; G06T 2207/10028; H04N 2007/145

(57) ABSTRACT

A handheld mobile apparatus with four-direction photography comprises a handheld mobile device and a four-direction photography part. The handheld mobile device comprises a front surface with a screen, a rear surface, an upper surface, a lower surface, a left surface and a right surface. The four-direction photography part comprises four photography devices that are respectively disposed on the upper surface, the lower surface, the left surface and the right surface. Accordingly, the four photography devices can capture image along four photography directions. At least one image captured is instantly displayed on the screen. Therefore, it can improve security of users to advance while using the handheld mobile apparatus. It is quite convenient for users to be capable of holding in both of an upright or a transversal holding position. And, it is quite humanized for users to arbitrarily choose a quantity of images to be displayed, and so on.

### BACKGROUND OF THE INVENTION

1. Field of the Invention

The present invention relates to a handheld mobile apparatus with four-direction photography, particularly with regard to a handheld mobile apparatus with four-direction photography having advantages of promoting security of users to advance while using the handheld mobile apparatus, of being quite convenient for users to be capable of holding the handheld mobile apparatus in both of an upright holding position thereof and a transversal holding position thereof for display, and of being quite humanized for users to arbitrarily choose a quantity of images to be displayed.

2. The Related Arts

With reference to FIGS. 6 and 7, traditional devices comprise a handheld mobile device 91 comprising a front surface 911 and a back surface 912. The front surface 911 comprises a screen 91A disposed thereon, and the front surface 911 and the back surface 912 are substantially parallel to each other. A front photography device 921 is used for proceeding self photography, and a back photography device 922 is used for proceeding photography of external objects.

The front photography device 921 and the back photography device 922 of the traditional devices are fixed in principle. Even for some of more specific models of the traditional devices equipped with photography devices having features capable of rotating in angles, the handheld mobile device 91 is still unable to capture images at photography angles along front, back, left and right directions of the handheld mobile device 91. As a result, if users view the screen 91A during advancing, their personal safety may be affected because they do not pay their attentions to surrounding circumstances.

Accordingly, it is necessary to research and develop technologies to solve conventional shortcomings mentioned above.

### SUMMARY OF THE INVENTION

An object of the present invention is to provide a handheld mobile apparatus with four-direction photography. The handheld mobile apparatus has advantages of promoting security of users to advance while using the handheld mobile apparatus, of being quite convenient for users to be capable of holding the handheld mobile apparatus in both of an upright holding position thereof and a transversal holding position thereof for display, and of being quite humanized for users to arbitrarily choose a quantity of images to be displayed, and so on. In particular, the present invention is desired to solve problems such as the problem that the front and back photography devices of the traditional devices are unable to capture images at photography angles along the front, back, left and right directions of the traditional handheld mobile device, and the problem that personal safety of users is affected because the users fail to pay their attentions to surrounding circumstances when the users view the screen during advancing, and so on.

Technical means of the present invention to solve the problems mentioned above is to provide a handheld mobile apparatus with four-direction photography. The mobile apparatus comprises a handheld mobile device and a four-direction photography part. The handheld mobile device comprises a front surface, a rear surface, an upper surface, a lower surface, a left surface and a right surface. The front surface comprises a screen disposed thereon, and the front surface and the rear surface are substantially parallel to each other.

The four-direction photography part comprises four photography devices. The four photography devices are respectively disposed and located on the upper surface, the lower surface, the left surface and the right surface.

Accordingly, the four photography devices are respectively used for image capturing along a first photography direction, a second photography direction, a third photography direction and a fourth photography direction, and at least one image captured by one of the four photography devices is instantly displayed on the screen.

The objects and advantages of the present invention mentioned above are easy to understand in depth from the following detailed descriptions and attached drawings of the selected embodiments of the present invention.

Accordingly, the present invention is explained and depicted in details based on the following embodiments in cooperation with drawings as follows.

### BRIEF DESCRIPTION OF THE DRAWINGS

FIG. 1A shows a schematic perspective view in accordance with an embodiment of the present invention;

FIG. 1B shows a schematic perspective view from a rear side viewing in accordance with an embodiment of the present invention;

FIG. 1C shows a schematic perspective view from another viewing angle in accordance with an embodiment of the present invention;

FIG. 2 shows a schematic perspective diagram presenting exemplification application in accordance with an embodiment of the present invention;

FIG. 3 shows a schematic top plan diagram presenting image capturing as depicted in FIG. 2 in accordance with an embodiment of the present invention;

FIGS. 4A and 4B respectively show schematic front plan views of different exemplification applications of image displaying for a mobile device in an upright holding position thereof in accordance with an embodiment of the present invention;

FIGS. 5A and 5B respectively show schematic front plan views of different exemplification applications of image displaying for a mobile device in a transversal holding position thereof in accordance with an embodiment of the present invention;

FIG. 6 shows a schematic perspective view of traditional handheld mobile devices; and

FIG. 7 shows a schematic perspective view from another viewing angle of the traditional handheld mobile devices.

### DETAILED DESCRIPTION OF PREFERRED EMBODIMENT

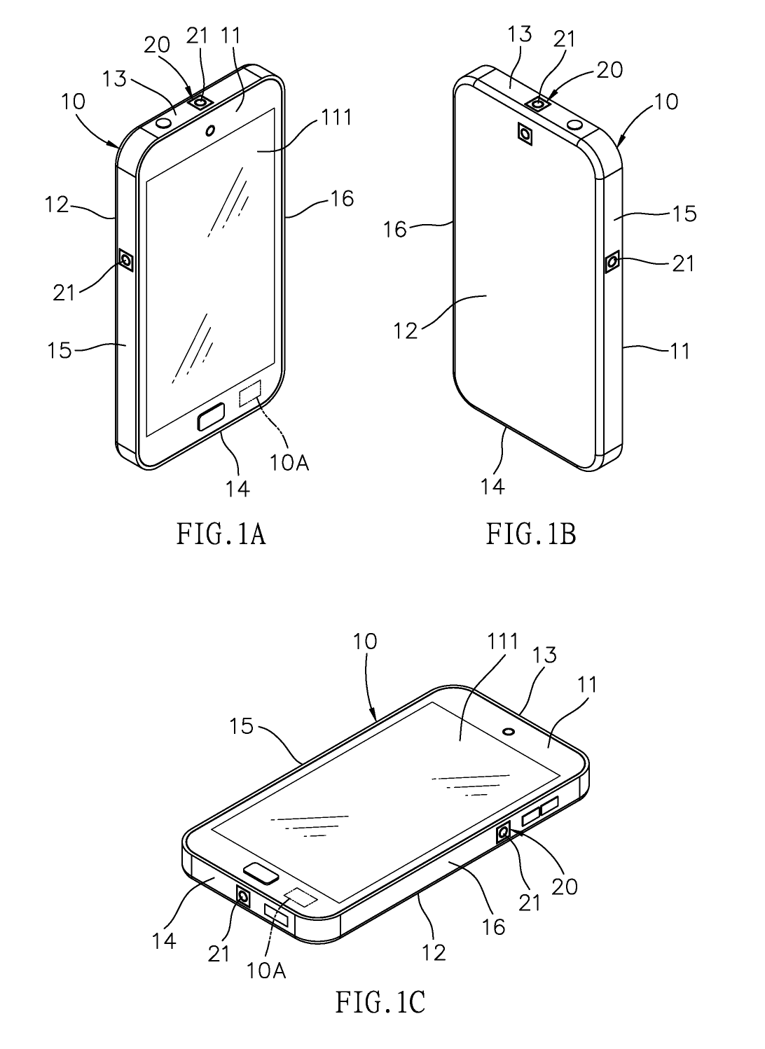

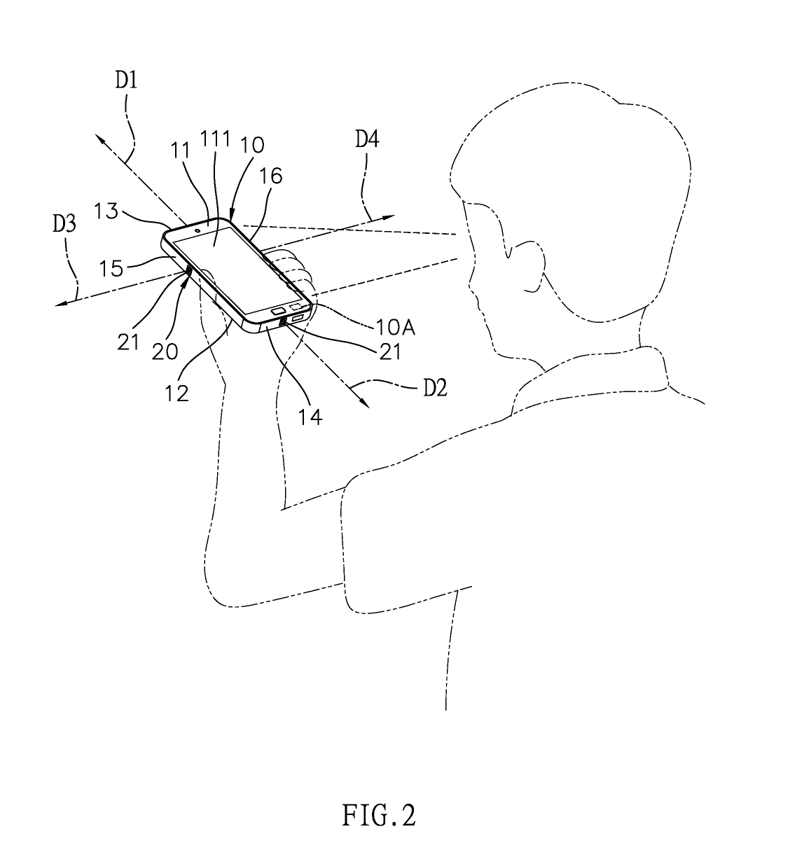

With reference to FIGS. 1A, 1B, 1C and 2, a handheld mobile apparatus with four-direction photography of the present invention comprises a handheld mobile device 10 and a four-direction photography part 20. The handheld mobile device 10 comprises a front surface 11, a rear surface 12, an upper surface 13, a lower surface 14, a left surface 15, and a right surface 16. The front surface 11 comprises a screen 111 disposed thereon, and the front surface 11 and the rear surface 12 are substantially parallel to each other.

A four-direction photography part 20 comprises four photography devices 21. The four photography devices are respectively disposed and located on the upper surface 13, the lower surface 14, the left surface 15 and the right surface 16.

Accordingly, the four photography devices 21 are respectively used for image capturing along a first photography direction D1, a second photography direction D2, a third photography direction D3 and a fourth photography direction D4, and at least one image captured by one of the four photography devices 21 is instantly displayed on the screen 111.

In practice, the handheld mobile device 10 may be a smart phone.

The photography devices 21 may be at least a selective one of a group consisting of a charge coupled device (abbreviated as “CCD”) and a complementary metal-oxide semiconductor (abbreviated as “CMOS”).

The charge coupled device (CCD) is used for a semiconductor capable of recording light changes for digital cameras, and is usually to use “megapixels” as a measuring unit. Megapixels, as emphasized in digital camera specifications, are referred to a resolution of the CCD, and it also represents how many photosensitive elements a digital camera is equipped.

The complementary metal-oxide semiconductor (CMOS) is also used for a semiconductor capable of recording light changes for digital cameras. CMOS makes no difference from the charge coupled device in appearance.

The handheld mobile device 10 can further comprise an image application (abbreviated as “APP”) 10A. The APP can be built-in or downloaded to be used for auxiliary controlling of the four photography devices 21 to respectively capture images along the first photography direction D1, the second photography direction D2, the third photography direction D3, and the fourth photography direction D4. At least one image captured by one of the four photography devices 21 is instantly displayed on the screen 111.

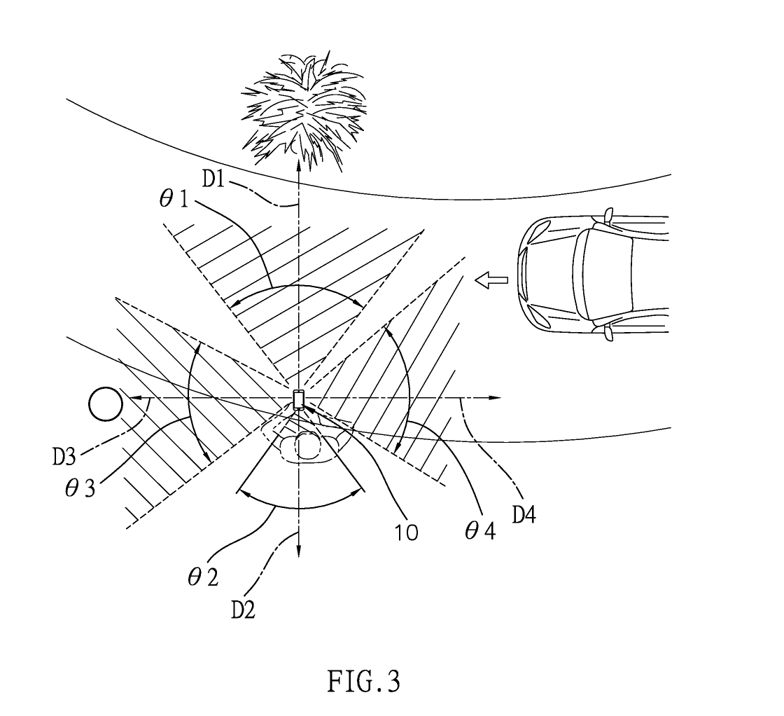

With reference to FIG. 3, the one of the four photography devices 21 along the first photography direction D1 has a first photography angle ƒ1. The one of the four photography devices 21 along the second photography direction D2 has a second photography angle θ2. The one of the four photography devices 21 along the third photography direction D3 has a third photography angle θ3. The one of the four photography devices 21 along the fourth photography direction D4 has a fourth photography angle θ4.

The first photography angle θ1, the second photography angle θ2, the third photography angle θ3 and the fourth photography angle θ4 are substantially evenly distributed on an imaginary plane parallel to the front surface 11 around the upper surface 13, the lower surface 14, the left surface 15 and the right surface 16.

Especially for explanation, it is popular to use smart mobile communication devices (including mobile phones, tablets, laptops) equipped with the mobile Internet to instantly browse news, texts, interactive communication software, and it is known as “phone sliding”.

In principle, such instant browsing action will not affect others if users are in a static state when riding or being seated. However, if the users are in a moving state when advancing, it may cause personal safety issues because users fail to pay their attentions to surrounding dangers. The present invention is primarily directed to instant browsing actions of users during advancing, and is designed to use the four photography devices 21 to respectively capture images along the first photography direction D1, the second photography direction D2, the third photography direction D3 and the fourth photography direction D4 (as shown in FIG. 2) and to instantly display at least one image captured by one of the four photography devices 21 on the screen 111. Examples are depicted as follows.

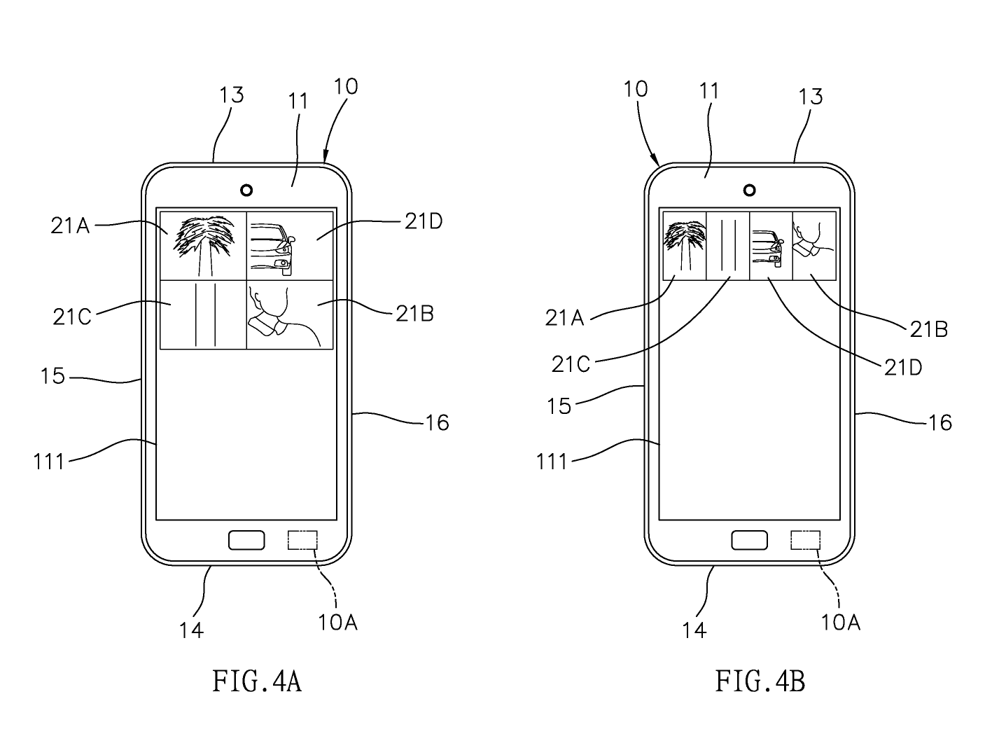

By holding the handheld mobile device 10 in an upright holding position thereof as an example, the four photography devices 21 respectively capture images along the first photography direction D1, the second photography direction D2, the third photography direction D3 and the fourth photography direction D4, and images captured by them are roughly displayed on the screen 111 in a matrix arrangement (with reference to a first image 21A, a second image 21B, a third image 21C, and a fourth image 21D as shown in FIG. 4A, and of course, an arrangement order regarding to up, down, left and right positions in the matrix arrangement can be adjusted by users at any time).

With reference to FIG. 4B, images captured can also be displayed on the screen 111 by being roughly lined up. The image display arrangement can be adjusted by the users entirely in accordance with needs and customs of the users.

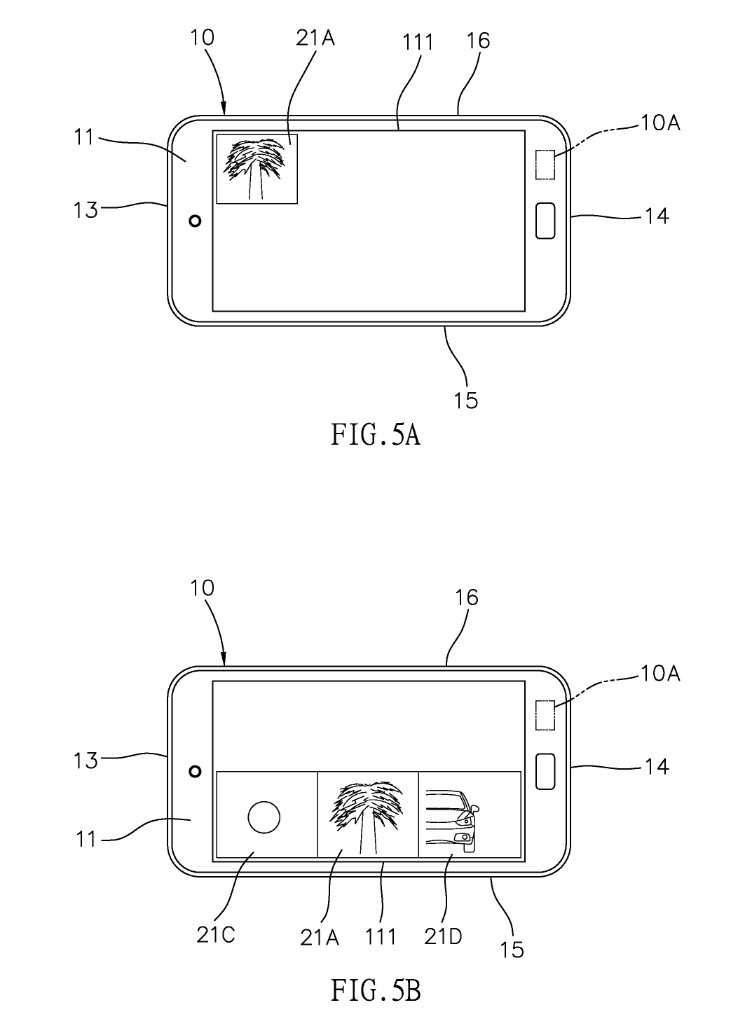

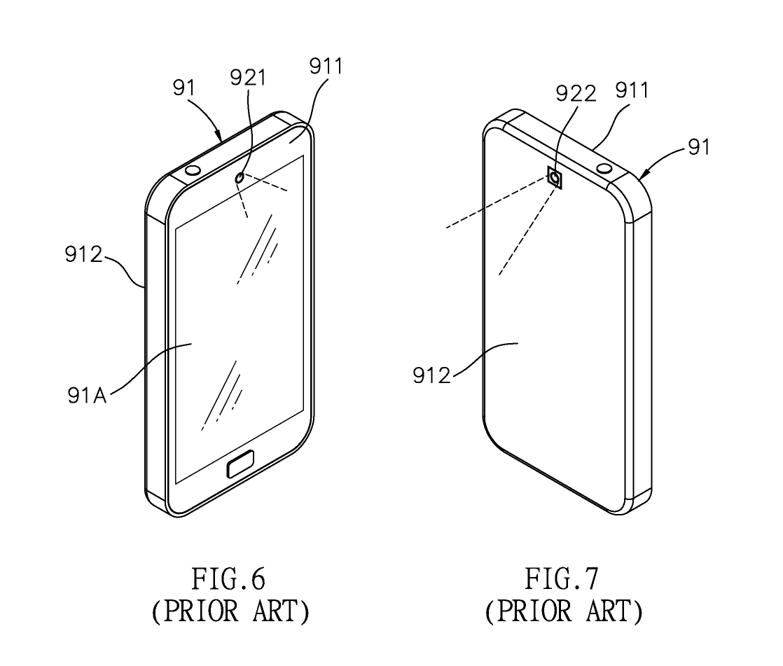

By holding the handheld mobile device 10 in a transversal holding position thereof as an example, the four photography devices 21 respectively capture images along the first photography direction D1, the second photography direction D2, the third photography direction D3 and the fourth photography direction D4 in a same way, and at this time, only one of the images is displayed by controlling as users' need as shown in FIG. 5A to assumedly display only the first image 21A. Alternatively, as shown in FIG. 5B, only the first image 21A, the third image 21C and the fourth image 21D are displayed (In fact, the second image 21 B is an own image of a holder of the handheld mobile device 10 in principle, and it actually does not need to be displayed).

In other words, if a line of sight of the holder is focused on the screen 111 when walking, the users can be reminded to be cautious to avoid getting hurt and can be warned by the at least one captured image regarding possibility to hit roadside trees, buildings, obstacles, and so on.

Advantages and effectiveness of the present invention are described below.

[1] Promoting security of users to use a handheld mobile apparatus when advancing: The photography devices 21 are disposed and installed on all four surfaces of the upper, lower, left and right surfaces 13, 14, 15 and 16 of the handheld mobile device 10 of the present invention and are used to capture images instantly, and the captured images are displayed on the screen 111. Users do not have to look up during advancing and can still be able to notice surrounding situations. Therefore, security of the users during advancing can be promoted.

[2] Displaying images being quite convenient when holding the handheld mobile apparatus in both of the upright holding position thereof and the transversal holding position thereof: No matter the handheld mobile apparatus is in the upright holding position thereof or used in the transversal holding position thereof (Generally online games players are mostly accustomed to hold the handheld mobile apparatus transversely), surrounding images can be displayed on the screen 111 in both holding positions thereof. Therefore, it is quite convenient to be capable of displaying images in both of the upright holding position and the transversal holding position of the handheld mobile apparatus.

[3] Being quite humanized for users to arbitrarily choose a quantity of images to be displayed: The present invention is designed for users to set up the quantity of images to be displayed on the screen 111 on their own based on their needs. For example, only the first image 21A (the front photography direction D1) is displayed, or only the first, third and fourth images (the front, left and right photography directions) are displayed. Therefore, it is quite humanized for users to arbitrarily choose the quantity of images to be displayed.

The present invention is only described in detail by preferred embodiments of the present invention as above. Any simple modifications and changes made to the embodiments are still covered within the inventive spirit of the present invention and the scope as defined in the following claims.

What is claimed is:

1. A handheld mobile apparatus with four-direction photography, comprising:
a handheld mobile device comprising a front surface, a rear surface, an upper surface, a lower surface, a left surface and a right surface, the front surface comprising a screen disposed thereon, and the front surface and the rear surface being parallel to each other; and
a four-direction photography part comprising four photography devices, the four photography devices respectively disposed and located on the upper surface, the lower surface, the left surface and the right surface;
wherein the four photography devices are respectively used for image capturing along a first photography direction, a second photography direction, a third photography direction and a fourth photography direction, and at least one image captured by one of the four photography devices is instantly displayed on the screen.

2. The handheld mobile apparatus with four-direction photography as claimed in claim 1, wherein the handheld mobile device is a smart phone.

3. The handheld mobile apparatus with four-direction photography as claimed in claim 1, wherein the four photography devices are at least a selective one of a group consisting of a charge coupled device and a complementary metal-oxide semiconductor.

4. The handheld mobile apparatus with four-direction photography as claimed in claim 1, wherein one of the four photography devices along the first photography direction has a first photography angle, another one of the four photography devices along the second photography direction has a second photography angle, still another one of the four photography devices along the third photography direction has a third photography angle, the other one of the four photography devices along the fourth photography direction has a fourth photography angle.

5. The handheld mobile apparatus with four-direction photography as claimed in claim 4, wherein the first, second, third and fourth photography angles are evenly distributed on an imaginary plane parallel to the front surface around the upper, lower, left and the right surfaces.
